(19) United States
(12) Patent Application Publication
(10) Pub. No.: US 2025/0252068 A1
(43) Pub. Date: Aug. 7, 2025

(54) DATA RECEIVING AND TRANSMITTING METHOD AND DATA RECEIVING AND TRANSMITTING DEVICE

(71) Applicant: REALTEK SEMICONDUCTOR CORPORATION, Hsinchu (TW)

(72) Inventors: Zhen-Ting HUANG, Hsinchu (TW); Wen-Hao LIU, Hsinchu (TW); Heng-Da NIE, Suzhou (CN); Chun-Hao LIN, Hsinchu (TW)

(21) Appl. No.: 19/044,057

(22) Filed: Feb. 3, 2025

(30) Foreign Application Priority Data
Feb. 6, 2024 (CN) 202410168827.7
Jun. 25, 2024 (CN) 202410830984.X

(51) Int. Cl. G06F 13/18; G06F 13/16

(52) U.S. Cl. CPC G06F 13/18; G06F 13/1642

(57) ABSTRACT

A data receiving and transmitting method includes following steps: receiving and transmitting a plurality of general priority data by a first request block; receiving and transmitting a plurality of high priority data by a second request block; and if the first request block is unable to receive and transmit a portion data of the plurality of general priority data, receiving and transmitting the portion data of the plurality of general priority data by the second request block.

### BACKGROUND OF THE INVENTION

### 1. Field of the Invention

The present disclosure relates to a data receiving and transmitting method and a data receiving and transmitting device, especially to a data receiving and transmitting method and a data receiving and transmitting device that assist in transmitting general priority data by high priority request blocks.

### 2. Description of Related Art

In data transmission, it is usually desirable for request block (e.g., USB Request Block (URB)) to carry the maximum amount of data. Therefore, data is aggregated to facilitate the transmission of the request block. However, the above-mentioned process will result in high-priority data being unable to achieve lower latency.

On the other hand, to improve the transmission efficiency of high-priority data and reduce transmission latency, if high-priority data is encountered, the request block will immediately proceed with data transmission. However, the above-mentioned operation will cause the general priority data following the high-priority data to wait, thereby resulting in a delay for the general priority data.

### SUMMARY OF THE INVENTION

In some aspects, an object of the present disclosure is to, but not limited to, provides a data receiving and transmitting method and a data receiving and transmitting device that makes an improvement to the prior art.

An embodiment of a data receiving and transmitting method of the present disclosure includes following steps: receiving and transmitting a plurality of general priority data by a first request block; receiving and transmitting a plurality of high priority data by a second request block; and if the first request block is unable to receive and transmit a portion data of the plurality of general priority data, receiving and transmitting the portion data of the plurality of general priority data by the second request block.

An embodiment of a data receiving and transmitting device of the present disclosure includes a memory and a processor. The memory is configured to store at least command. The processor is configured to read the at least command to execute following steps: receiving and transmitting a plurality of general priority data by a first request block; receiving and transmitting a plurality of high priority data by a second request block; and if the first request block is unable to receive and transmit a portion data of the plurality of general priority data, receiving and transmitting the portion data of the plurality of general priority data by the second request block.

Technical features of some embodiments of the present disclosure make an improvement to the prior art. The data receiving and transmitting method and the data receiving and transmitting device of the present disclosure assist in the transmission of the general priority data through the high priority request blocks, thereby improving the transmission efficiency of both the high priority data and the general priority data and reducing transmission delays.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a data receiving and transmitting device of the present disclosure.

FIG. 2 shows an embodiment of a flow diagram of a data receiving and transmitting method of the present disclosure.

FIG. 3A shows an embodiment of an operation diagram of a data receiving and transmitting device of the present disclosure.

FIG. 3B shows an embodiment of an operation diagram of a data receiving and transmitting device of the present disclosure.

FIG. 4 shows an embodiment of an operation diagram of a data receiving and transmitting device of the present disclosure.

FIG. 5 shows an embodiment of a flow diagram of a data receiving and transmitting method of the present disclosure.

FIG. 6 shows an embodiment of a data transmission and an acknowledgment signal of the present disclosure.

FIG. 7 shows an embodiment of a data transmission and an acknowledgment signal of the present disclosure.

### DETAILED DESCRIPTION OF THE PREFERRED EMBODIMENTS

To address the problem of delays in general priority data caused by the prioritized transmission of high priority data, the present disclosure provides a data receiving and transmitting method and a data receiving and transmitting device, which will be explained in detail as shown below.

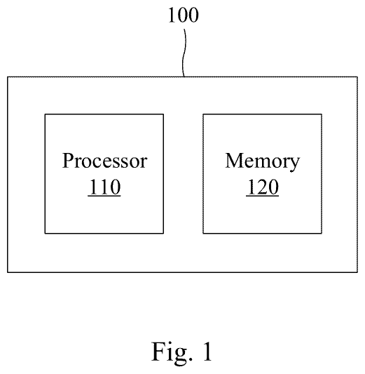

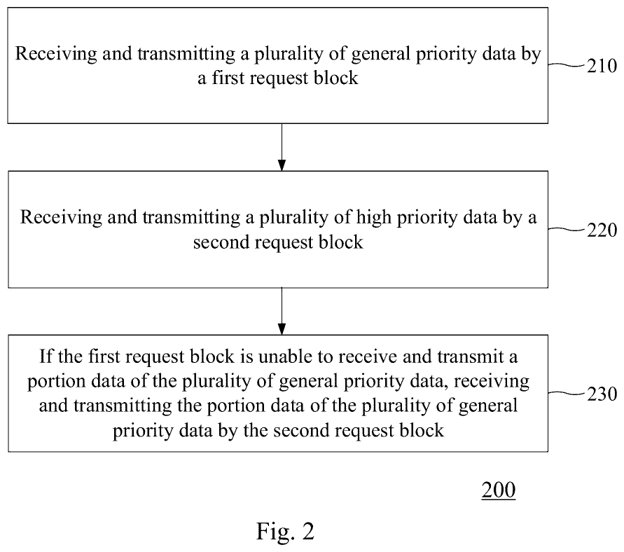

FIG. 1 shows an embodiment of a data receiving and transmitting device 100 of the present disclosure. As shown in the figure, the data receiving and transmitting device 100 includes a processor 110 and a memory 120. The memory 120 is utilized to store at least one command. The processor 110 is utilized to read at least one command to execute data transmission. For facilitating the understanding of operations of the data receiving and transmitting device 100, please refer to FIG. 2. FIG. 2 shows an embodiment of a flow diagram of a data receiving and transmitting method 200 of the present disclosure.

In step 210, receiving and transmitting a plurality of general priority data by a first request block. In step 220, receiving and transmitting a plurality of high priority data by a second request block. For example, the present disclosure can utilize the first request block (e.g., USB Request Block (URB)) to receive and transmit the plurality of general priority data. In addition, the present disclosure can utilize the second request block (e.g., URB) to receive and transmit the plurality of high priority data.

In step 230, if the first request block is unable to receive and transmit a portion data of the plurality of general priority data, receiving and transmitting the portion data of the plurality of general priority data by the second request block. For example, if the first request block (e.g., URB) is fully loaded and is unable to receive and transmit the portion data of the plurality of general priority data, the second request block (e.g., URB) can assist in receiving and transmitting the portion data of the plurality of general priority data, thereby reducing transmission delays of general priority data.

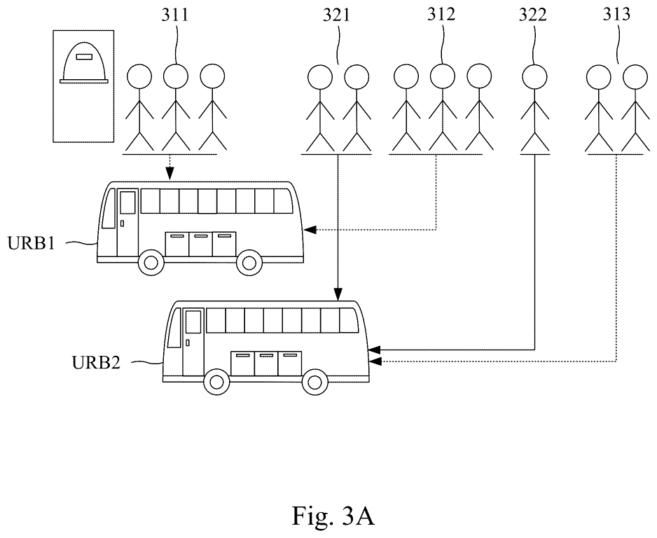

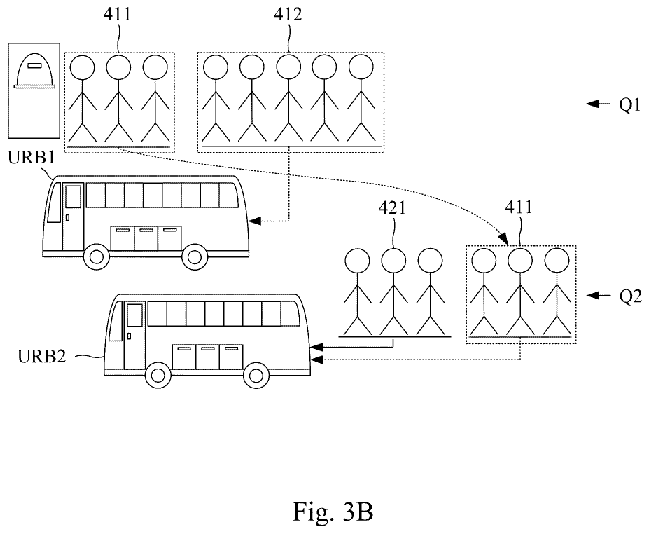

FIG. 3A shows an embodiment of an operation diagram of a data receiving and transmitting device 100 of the present disclosure. As shown in the figure, to facilitate understanding, the general priority data is represented by general passengers 311, 312, 313, the high priority data is represented by high priority passengers 321, 322, the first request block is represented by a first bus URB1, and the second request block is represented by a second bus URB2.

First of all, the general passengers 311, 312, 313 and the high priority passengers 321, 322 are queued into the same queue. Subsequently, the general passengers 311, 312 are distributed from the queue to the first bus URB1 according to the order in the queue, and the high priority passengers 321, 322 are distributed from the queue to the second bus URB2 according to the order in the queue. However, since the first bus URB1 is fully loaded, the general passenger 313 is unable to board the first bus URB1. As this time, the general passenger 313 can be distributed from the queue to the second bus URB2, and the second bus URB2 will then carry the general passenger 313. As described above, the general priority data, the first request block, and the second request block are represented respectively by the general passenger 313, the first bus URB1, and the second bus URB2. From the above-mentioned example, it can be seen that the present disclosure can utilize the second request block URB2 to assist in receiving and transmitting the general priority data 313 when the first request block URB1 is unable to receive and transmit the general priority data 313, thereby reducing the transmission delay of the general priority data 313. On the other hand, the present disclosure can utilize the second request block URB2 to assist in receiving and transmitting the general priority data 313 without adding any additional delay to the high priority data 321 and 322. It should be noted that the packet order of the high priority data packets in the present disclosure will maintain their original high priority order. This means that the high priority data will still be sent early and will not be delayed due to waiting for transmission (only the existing portion needs to be processed). Even if the first request block URB1 and the second request block URB2 in FIG. 3A are interchanged, the implementation can still follow the corresponding method shown in FIG. 3A.

FIG. 3B shows an embodiment of an operation diagram of a data receiving and transmitting device 100 of the present disclosure. As shown in the figure, to facilitate understanding, the general priority data is represented by general passengers 411, 412, the high priority data is represented by a high priority passenger 421, the first request block is represented by a first bus URB1, and the second request block is represented by a second bus URB2.

First of all, the general passengers 411, 412 are queued into a first queue Q1. Secondly, the high priority passenger 421 is queued into a second queue Q2. After the second bus URB2 carries the high priority passenger 421, if there is still general passenger 411 related to the first bus URB1, then the general passenger 411 can be distributed from the first queue Q1 to the second bus URB2, and the second bus URB2 will then carry the general passenger 411. In addition, the general passenger 412 can be distributed to the first bus URB1. As described above, the general priority data, the high priority data, the first request block, and the second request block are represented respectively by the general passenger 411, the high priority passenger 421, the first bus URB1, and the second bus URB2. From the above-mentioned example, it can be seen that after the second bus URB2 receives and transmits the high priority passenger 421, the present disclosure can still utilize the second request block URB2 to receive and transmit the general priority data 411 if there is still general passenger 411 related to the first bus URB1.

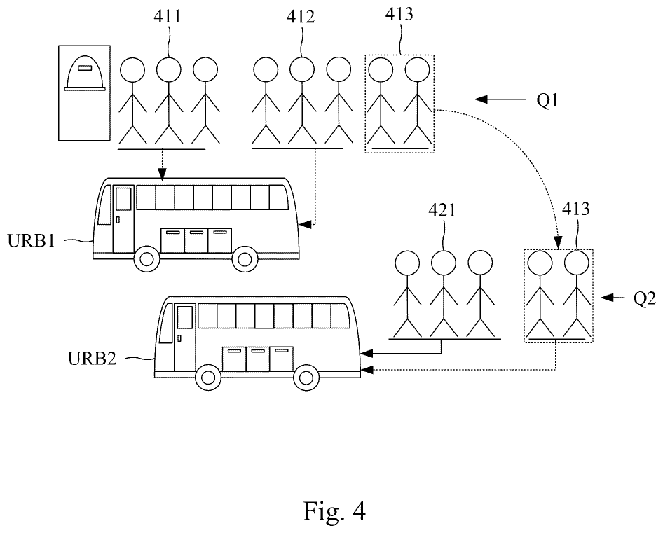

FIG. 4 shows an embodiment of an operation diagram of a data receiving and transmitting device 100 of the present disclosure. As shown in the figure, to facilitate understanding, the general priority data is represented by general passengers 411, 412, 413, the high priority data is represented by a high priority passenger 421, the first request block is represented by a first bus URB1, and the second request block is represented by a second bus URB2.

First of all, the general passengers 411, 412, 413 are queued into a first queue Q1. Subsequently, the general passengers 411, 412 are distributed from the first queue Q1 to the first bus URB1 according to the order in the queue. Secondly, the high priority passenger 421 is queued into a second queue Q2, and the high priority passenger 421 is distributed from the second queue Q2 to the second bus URB2 according to the order in the queue. However, since the first bus URB1 is fully loaded, the general passenger 413 is unable to board the first bus URB1. As this time, the general passenger 413 can be distributed from the first queue Q1 to the second bus URB2, and the second bus URB2 will then carry the general passenger 413. As described above, the general priority data, the first request block, and the second request block are represented respectively by the general passenger 413, the first bus URB1, and the second bus URB2. From the above-mentioned example, it can be seen that the present disclosure can utilize the second request block URB2 to assist in receiving and transmitting the general priority data 413 when the first request block URB1 is unable to receive and transmit the general priority data 413, thereby reducing the transmission delay of the general priority data.

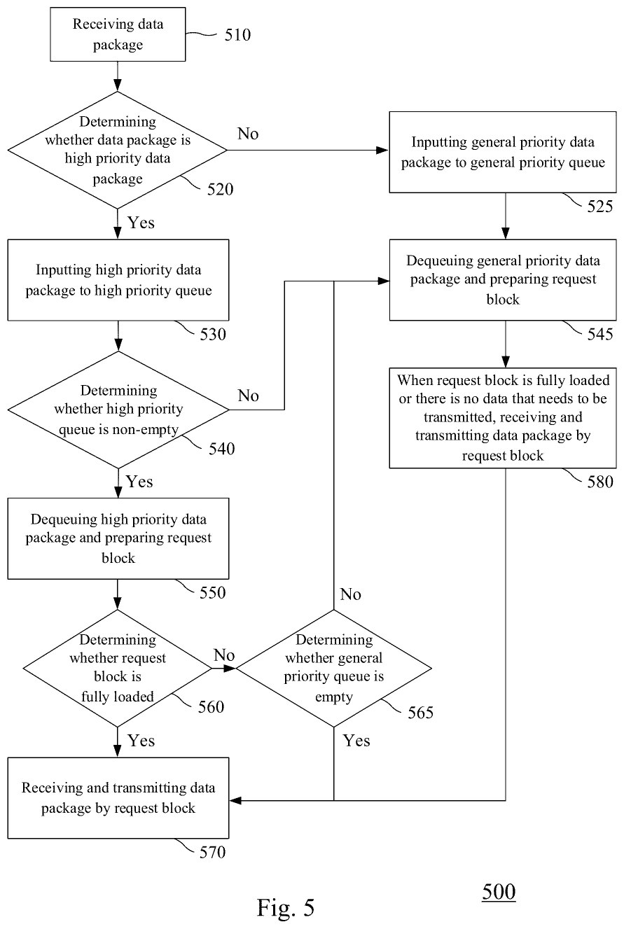

FIG. 5 shows an embodiment of a flow diagram of a data receiving and transmitting method 500 of the present disclosure. As shown in the figure, in step 510, receiving a data package. Subsequently, in step 520, determining whether the data package is a high priority data package. If the data package is the high priority data package, step 530 is executed for inputting (e.g., inserting) the high priority data package to a high priority queue. In addition, if the data package is not the high priority data package, step 525 is executed for inputting (e.g., inserting) the general priority data package to a general priority queue.

Subsequently, in step 540, determining whether the high priority queue is non-empty. If the high priority queue is non-empty, step 550 is executed for dequeuing the high priority data package and preparing a request block (e.g., preparing Bulk URB). In addition, if the high priority queue is not non-empty, step 545 is executed for dequeuing the general priority data package and preparing the request block (e.g., preparing Bulk URB).

Subsequently, in step 560, determining whether the request block is fully loaded. If the request block is fully loaded, step 570 is executed for receiving and transmitting a data package by the request block. If the request block is not fully loaded, step 565 is executed for determining whether a general priority queue is empty. If the general priority queue is empty, step 570 is executed for receiving and transmitting the data package by the request block. If the general priority queue is not empty, step 545 is executed for dequeuing the general priority data package and preparing the request block (e.g., preparing Bulk URB). Subsequently, in step 580, when the request block is fully loaded or there is no data that needs to be transmitted, receiving and transmitting the data package by the request block.

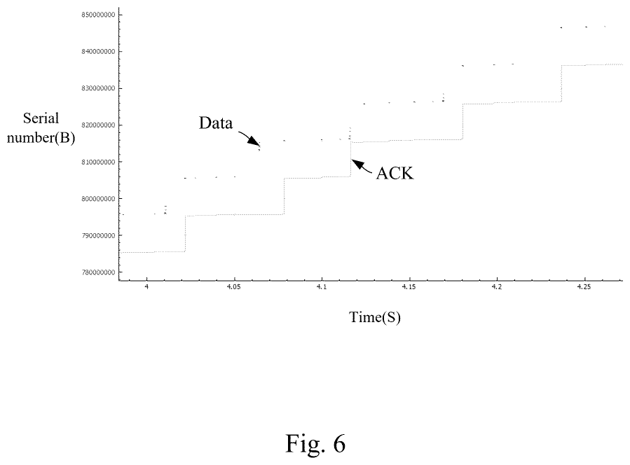

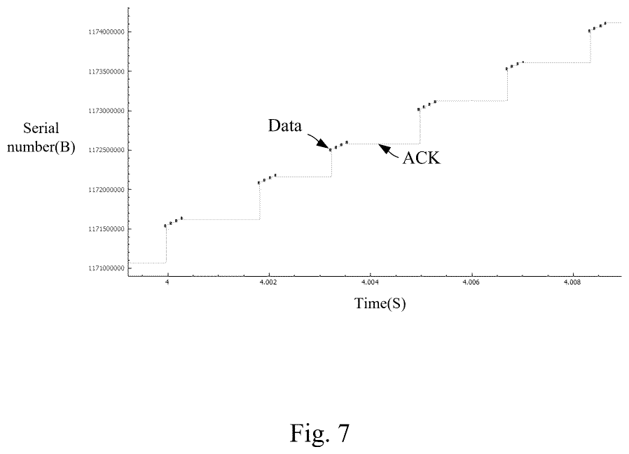

FIG. 6 and FIG. 7 show embodiments of a data transmission and an acknowledgment signal of the present disclosure. FIG. 6 show an embodiment without the use of the data receiving and transmitting methods 200, 500 and the data receiving and transmitting device 100 of the present disclosure. As shown in the figure, there is a significant latency between the data transmission and the acknowledgment signal (ACK), which leads to delays in all data transmission processes (e.g., data receiving and transmitting processes). In contrast, FIG. 7 show an embodiment that adopts the data receiving and transmitting methods 200, 500 and the data receiving and transmitting device 100 of the present disclosure. As shown in the figure, there is nearly no latency between the data transmission and the acknowledgment signal (ACK), resulting in almost no delay in all data transmission processes (e.g., data receiving and transmitting processes).

In some embodiments, reference is now made to the following table 1 to illustrate the advantages that adopts the data receiving and transmitting methods 200, 500 and the data receiving and transmitting device 100 of the present disclosure:

TABLE 1

| | |
|---|---|
| TX and RX | 6 TX and 6 RX |

| | | | |
|---|---|---|---|
| Present disclosure | 4.544103 | Gbps | 4.663229 G |
| Prior art | 3.957277 | G | 3.089599 G |

As shown in Table 1, the transmission (TX) and reception (RX) speeds using the data receiving and transmitting methods 200, 500 and the data receiving and transmitting device 100 of the present disclosure can reach 4.544103G. In contrast, the transmission (TX) and reception (RX) speeds of the prior art are only 3.957277G. Furthermore, under the condition of using multiple transmission (TX) and reception (RX) channels, the transmission (TX) and reception (RX) speeds using the data receiving and transmitting methods 200, 500 and the data receiving and transmitting device 100 of the present disclosure can further reach 4.663229G. In contrast, the transmission (TX) and reception (RX) speeds of the prior art are mutually affected, resulting in speeds of only 3.089599G.

It is noted that the present disclosure is not limited to the embodiments as shown in FIG. 1 to FIG. 7, they are merely examples for illustrating one of the implements of the present disclosure, and the scope of the present disclosure shall be defined on the bases of the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The data receiving and transmitting method and the data receiving and transmitting device of the present disclosure assist in the transmission of general priority data through high priority request blocks, thereby improving the transmission efficiency of both high priority data and general priority data and reducing transmission delays.

It is noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A data receiving and transmitting method, executed by a processor reading at least one command stored in a memory, comprising:
receiving and transmitting a plurality of general priority data by a first request block;
receiving and transmitting a plurality of high priority data by a second request block; and
if the first request block is unable to receive and transmit a portion data of the plurality of general priority data, receiving and transmitting the portion data of the plurality of general priority data by the second request block.

2. The data receiving and transmitting method of claim 1, further comprising:
after the second request block receives and transmits the plurality of high priority data, if the portion data of the plurality of general priority data related to the first request block exist, receiving and transmitting the portion data of the plurality of general priority data by the second request block.

3. The data receiving and transmitting method of claim 1, further comprising:
queuing the plurality of general priority data and the plurality of high priority data into queue data; and
distributing the plurality of general priority data from the queue data to the first request block, and distributing the plurality of high priority data from the queue data to the second request block; and
wherein if the first request block is unable to receive and transmit the portion data of the plurality of general priority data, receiving and transmitting the portion data of the plurality of general priority data by the second request block comprises:
if the first request block is unable to receive and transmit the portion data of the plurality of general priority data from the queue data, receiving and transmitting the portion data of the plurality of general priority data from the queue data by the second request block.

4. The data receiving and transmitting method of claim 1, further comprising:
queuing the plurality of general priority data into first queue data;
distributing the plurality of general priority data from the first queue data to the first request block;
queuing the plurality of high priority data into second queue data; and
distributing the plurality of high priority data from the second queue data to the second request block; and
wherein if the first request block is unable to receive and transmit the portion data of the plurality of general priority data, receiving and transmitting the portion data of the plurality of general priority data by the second request block comprises:
if the first request block is unable to receive and transmit the portion data of the plurality of general priority data from the first queue data, receiving and transmitting the portion data of the plurality of general priority data from the first queue data by the second request block.

5. The data receiving and transmitting method of claim 1, further comprising:
determining whether the second request block is fully loaded; and
if the second request block is not fully loaded, receiving and transmitting the portion data of the plurality of general priority data by the second request block.

6. The data receiving and transmitting method of claim 1, further comprising:
inputting the plurality of high priority data into a queue;
determining whether the queue is non-empty; and
if the queue is not non-empty, receiving and transmitting the portion data of the plurality of general priority data by the second request block.

7. A data receiving and transmitting device, comprising:
a memory, configured to store at least one command; and
a processor, configured to read the at least one command to execute following steps:
receiving and transmitting a plurality of general priority data by a first request block;
receiving and transmitting a plurality of high priority data by a second request block; and
if the first request block is unable to receive and transmit a portion data of the plurality of general priority data, receiving and transmitting the portion data of the plurality of general priority data by the second request block.

8. The data receiving and transmitting device of claim 7, wherein the processor is further configured to read the at least one command to execute following step:
after the second request block receives and transmits the plurality of high priority data, if the portion data of the plurality of general priority data related to the first request block exist, receiving and transmitting the portion data of the plurality of general priority data by the second request block.

9. The data receiving and transmitting device of claim 7, wherein the processor is further configured to read the at least one command to execute following steps:
queuing the plurality of general priority data and the plurality of high priority data into queue data; and
distributing the plurality of general priority data from the queue data to the first request block, and distributing the plurality of high priority data from the queue data to the second request block; and
wherein if the first request block is unable to receive and transmit the portion data of the plurality of general priority data, receiving and transmitting the portion data of the plurality of general priority data by the second request block, which is executed by the processor reading the at least one command, comprises:
if the first request block is unable to receive and transmit the portion data of the plurality of general priority data from the queue data, receiving and transmitting the portion data of the plurality of general priority data from the queue data by the second request block.

10. The data receiving and transmitting device of claim 7, wherein the processor is further configured to read the at least one command to execute following steps:
queuing the plurality of general priority data into first queue data;
distributing the plurality of general priority data from the first queue data to the first request block;
queuing the plurality of high priority data into second queue data; and
distributing the plurality of high priority data from the second queue data to the second request block; and
wherein if the first request block is unable to receive and transmit the portion data of the plurality of general priority data, receiving and transmitting the portion data of the plurality of general priority data by the second request block, which is executed by the processor reading the at least one command, comprises:
if the first request block is unable to receive and transmit the portion data of the plurality of general priority data from the first queue data, receiving and transmitting the portion data of the plurality of general priority data from the first queue data by the second request block.

11. The data receiving and transmitting device of claim 7, wherein the processor is further configured to read the at least one command to execute following steps:
determining whether the second request block is fully loaded; and
if the second request block is not fully loaded, receiving and transmitting the portion data of the plurality of general priority data by the second request block.

12. The data receiving and transmitting device of claim 7, wherein the processor is further configured to read the at least one command to execute following steps:
inputting the plurality of high priority data into a queue;
determining whether the queue is non-empty; and
if the queue is not non-empty, receiving and transmitting the portion data of the plurality of general priority data by the second request block.
